(19) United States
(12) Patent Application Publication
(10) Pub. No.: US 2011/0155522 A1
(43) Pub. Date: Jun. 30, 2011

(54) METHOD AND SYSTEM OF OPERATING AN EMERGENCY BRAKE

(76) Inventor: Andrew Miller, Western Australia (AU)

(21) Appl. No.: 13/056,698

(22) PCT Filed: Jul. 31, 2009
(86) PCT No.: PCT/AU09/00982

§ 371 Date: Mar. 17, 2011

(30) Foreign Application Priority Data
Aug. 1, 2008 (AU) 2008903949

(51) Int. Cl. B60T 8/72; B60T 7/12; B60T 8/34

(52) U.S. Cl. 188/110

(57) ABSTRACT

An emergency brake system (10) comprises first and second fluid communication paths (20) and (22) which provide fluid communication between a brake (18) and a hydraulic fluid tank (24). A first valve is provided in the first path (20) to vary pressure in the brake line (26) to a pressure P₁ enabling the brake to apply a braking torque of T₁ and a second valve (30) is provided in the path (22) to vary brake line pressure to a pressure P2 enabling the brake (18) to apply a braking torque of T₂ where T₂>T₁. The system (10) senses the speed of a machine to which the brake (18) is coupled. Depending on the sensed speed of the machine when the emergency brake (18) is applied the system (10) will open one or both of the paths to control the braking torque applied by the brake (18).

### FIELD OF THE INVENTION

The present invention relates to a system and method for operating an emergency brake and in particular, but not exclusively, to a system and method of operating a drive line emergency brake.

### BACKGROUND OF THE INVENTION

Emergency or park brakes are often provided on commercial, transport or heavy vehicles to arrest motion of a vehicle in an emergency situation, for example, where the normal service brake is inoperable, for example, due to a loss of pneumatic or hydraulic pressure. An emergency brake system may operate directly on the wheels of a vehicle, or alternately may be mounted on a drive line of the vehicle to provide braking torque to the or each drive shaft of the vehicle. In relation to a drive shaft mounted emergency brake, the braking torque applied to the drive shaft is transmitted through the differential to the driven wheels. This is advantageous as the differential multiplies the torque by the diff ratio (typically around 4:1), thus smaller brakes with less braking force can be used to retard a larger vehicle than similar sized brakes mounted on the wheels. A potential issue with this arrangement is that a sudden application of braking torque to the drive line can cause shock loads through the drive line which may damage drive line components. This may be particularly important during dynamic applications of the brake.

Embodiments of the present invention was developed with a view to overcoming the above mentioned deficiency in drive line brake systems. However, embodiments of the present invention are not limited in their application to drive line brake systems and may be incorporated in wheel brakes, or indeed in other machines which require braking of rotating components such as crane winches.

### SUMMARY OF THE INVENTION

One aspect of the invention may provide a method of operating an emergency brake for arresting the motion of a motor vehicle, the method comprising:
sensing the speed V of the motor vehicle; and,
upon activating the emergency brake, automatically applying braking torque to a rotating component of the motor vehicle at a rate dependent on the sensed speed V.

Automatically applying braking torque may comprise:
when V>Vₛₑₜ increasing braking torque from Tₘᵢₙ to T₁; and subsequently increasing braking torque from T₁ to Tₘₐₓ; and,
   when V<Vₛₑₜ increasing braking torque from Tₘᵢₙ to T₂, where Tₘₐₓ>T₂>T₁>Tₘᵢₙ.

In one embodiment when V>Vₛₑₜ, the step of subsequently increasing braking torque from T₁ to Tₘₐₓ may comprise increasing braking torque from T₁ to T₂ where T₂>T₁>Tₘᵢₙ and subsequently increasing braking torque from T₂ to Tₘₐₓ.

The method may, comprise when V>Vₛₑₜ, and the emergency brake is activated providing a delay in increasing braking torque from T₁ to T₂.

A second aspect of the invention may provide a method of operating an emergency brake for arresting the motion of a motor vehicle where the emergency brake applies a minimum braking torque Tₘᵢₙ when an associated brake line pressure is at a first pressure P_{A} and applies a maximum braking torque Tₘₐₓ when brake line pressure is at a second pressure P_{B}, the method comprising:
sensing the speed V of the motor vehicle; and,
upon activating the emergency brake, automatically varying brake line pressure form P_{A} to P_{B} at a rate dependent on the sensed speed V.

For example when the brake is a spring applied hydraulic released brake P_{A} is a maximum brake line pressure Pₘₐₓ and P_{B} is a minimum brake line pressure Pₘᵢₙ. Conversely when the emergency brake is a hydraulic applied brake P_{A} is a minimum brake line pressure Pₘᵢₙ and P_{B} is a maximum brake line pressure Pₘₐₓ. In both instances the application braking torque is varied from Tₘᵢₙ to Tₘₐₓ at a rate dependent on sensed speed V.

A third aspect of the invention may provide a method of operating an emergency brake for arresting the motion of a motor vehicle where the emergency brake has a fully released state when an associated brake line pressure is at Pₘₐₓ and a fully applied state when brake line pressure is at Pₘᵢₙ where Pₘₐₓ>Pₘᵢₙ, the method comprising:
sensing the speed V of the motor vehicle;
upon activating the emergency brake, automatically relieving brake line pressure at a rate dependent on the sensed speed V.

Automatically relieving brake line pressure may comprise relieving brake line pressure from Pₘₐₓ to P₁ to P when V>Vₛₑₜ where the Vₛₑₜ>0 and P₁>Pₘᵢₙ; and, subsequently relieving P₁ to Pₘᵢₙ; and,
relieving Pₘₐₓ to P₂ when V<Vₛₑₜ and subsequently relieving P₂ to Pₘᵢₙ, where P₁>P₂>Pₘᵢₙ.

In one embodiment when V>Vₛₑₜ, the step of subsequently relieving P₁ to Pₘᵢₙ may comprise relieving brake line pressure from P₁ to P₂ where P₁>P₂>Pₘᵢₙ and subsequently relieving brake line pressure from P₂ to Pₘᵢₙ.

The method may, comprise when V>Vₛₑₜ, and the emergency brake is activated, delaying the relieving of the brake line pressure from P₁ to P₂.

The method may comprise automatically activating the emergency brake upon detection of an interlock event relating to operation of the vehicle.

The interlock event may comprise any one of (a) a driver's door of the vehicle being open; (b) any door of the vehicle being open; (c) a driver's seat belt being disengaged while a driver is on a driver's seat; (d) a passenger's seat being disengaged while a passenger is on a seat associated with the passenger's seat belt.

The method may comprise coupling the emergency brake with a drive line component of the motor vehicle wherein the emergency brake when applied applies braking torque to the drive line component.

A fourth aspect of the invention may provide a method of operating an emergency brake for arresting motion of a machine where the brake has a fully released state when an associated brake line pressure is at Pₘₐₓ and a fully applied state when brake line pressure is at Pₘᵢₙ where Pₘₐₓ>Pₘᵢₙ, the method comprising:
providing n parallel fluid communication paths between the brake and a fluid tank where n is an integer >2, wherein said fluid communication paths are closed prior to activation of the emergency brake and each fluid communication path, when open, is configured to enable brake line pressure to be relieved to respective pressures P₁, P₂, . . . Pₙ where Pₘₐₓ>P₁>P₂> . . . >Pₙ>Pₘᵢₙ;
sensing a speed V of the machine or a component thereof; and,
automatically opening one or more of the fluid communication paths upon activation of the emergency brake dependent on the sensed speed V.

The method may comprise opening the path enabling brake line pressure to be relieved to pressure P₁ when Vᵢ₋₁>V≧V₁ and the emergency brake is activated where Vᵢ₋₁>Vᵢ.

The method may comprise, subsequent to the opening of the path commensurate with the sensed speed V being at V₁, subsequently opening each other; path enabling progressive pressure relief to Pₘᵢₙ.

In one embodiment where the machine is a motor vehicle, the method may comprise automatically activating the emergency brake upon detection of an interlock event relating to operation of the vehicle.

The detecting an interlock event may comprise detecting any one of (a) a driver's door of the vehicle being open; (b) any door of the vehicle being open; (c) a driver's seat belt being disengaged while a driver is on a driver's seat; (d) a passenger's seat being disengaged while a passenger is on a seat associated with the passenger's seat belt.

The method may comprise coupling the emergency brake with a drive line component of the motor vehicle wherein the emergency brake when applied applies braking torque to the drive line component.

A fifth aspect of the invention may provide an emergency brake system having a brake with a fully released state when an associated brake line pressure is at Pₘₐₓ and a fully applied state when brake line pressure is at Pₘᵢₙ where Pₘₐₓ is greater than Pₘᵢₙ the emergency brake system comprising:
at least first and second fluid communication paths between the brake and a fluid tank, wherein each path is closed prior to activation of the emergency brake;
a first pressure relief valve configured to reduce brake line pressure to P₁ in the first fluid communication path;
a second pressure relief valve which is configured to reduce brake line pressure to P₂ in the second fluid communication path wherein Pₘₐₓ>P₁>P₂>Pₘᵢₙ;
a speed sensing device of a sensing a speed V of a machine or a component thereof to which the emergency brake is coupled;
wherein one or more of the fluid communication paths is opened to automatically relieve brake line pressure upon activation of the emergency brake dependent on the sensed speed V.

The brake may be configured so that when V>Vₛₑₜ and the emergency brake system is activated: the first fluid communication path is opened to relieve brake line pressure to P₁; and, the brake line pressure is subsequently relieved to Pₘᵢₙ; and,
when V<Vₛₑₜ and the emergency brake is activated, the second fluid communication path is opened to relieve brake line pressure to P₂ and the brake line pressure is subsequently relieved to Pₘᵢₙ, where P₁>P₂>Pₘᵢₙ.

The brake system may be configured so that when V>Vₛₑₜ: the second fluid communication path is opened after the brake line pressure is relieved to pressure P1 to relieve brake line pressure to P₂ where P₁>P₂>Pₘᵢₙ.

The brake system may be configured so that when V>Vₛₑₜ, and the emergency brake system is activated: there is a delay between the brake line pressure relieving to P₁ and subsequently opening the second fluid communication path.

According to a sixth aspect of the invention there is provided an emergency brake system having a brake with a fully released state where braking torque applied by the brake is at a minimum Tₘᵢₙ and an associated brake line pressure is at P_{A} and a fully applied state where braking torque applied by the brake is at a maximum Tₘₐₓ and brake line pressure is at P_{B} the emergency brake system comprising:
at least first and second fluid communication paths between the brake and a fluid tank, wherein each path is closed prior to activation of the emergency brake;
a first valve in the first fluid communication path configured to vary brake line pressure to P₁ to apply braking torque T₁;
a second valve in the second fluid communication path which is configured to vary brake line pressure to P₂ to apply a braking torque T₂ where Tₘₐₓ>T₂>T₁>Tₘᵢₙ and P1, P₂ are between P_{A} and P_{B};
a speed sensing device of a sensing a speed V of a machine or a component thereof to which the emergency brake is coupled;
wherein one or both of the fluid communication paths is opened to automatically relieve brake line pressure upon activation of the emergency brake dependent on the sensed speed V.

In one embodiment when V>Vₛₑₜ and the emergency brake is activated, the first fluid communication path is opened to enable the brake to apply a braking torque of T₁; and subsequently apply braking torque Tₘₐₓ; and,
when V<Vₛₑₜ and the emergency brake is activated, the second fluid communication path is opened to enable the brake to apply braking torque of T₂ and subsequently apply braking torque of Tₘₐₓ.

In this embodiment when V>Vₛₑₜ, the second fluid communication path is opened after the braking torque has reached T₁ to subsequently enable the brake to apply braking torque T₂.

The brake system may comprise sensors for detecting one or more interlock events relating to operation of the machine wherein the emergency brake system is configured to automatically activate when a sensor detects an interlock event.

When the machine is a motor vehicle the sensors may comprise sensor to detect any one of (a) a driver's door of the vehicle being open; (b) any door of the vehicle being open; (c) a driver's seat belt being disengaged while a driver is on a driver's seat; (d) a passenger's seat being disengaged while a passenger is on a seat associated with the passenger's seat belt.

The brake may comprise a braking surface coupled with a drive line component of the motor vehicle and at least one a friction pad, wherein when the emergency brake is the at least one friction pad is pressed against the braking surface to apply applies braking torque to the drive line component

The brake system may comprise a first normally open solenoid check valve in the first fluid communication path and a second normally open solenoid check valve in the second fluid communication path wherein the first and second communication paths are closed by supplying electrical power to the respective solenoid check valves.

### BRIEF DESCRIPTION OF THE DRAWINGS

An embodiment of the present invention will now be described by way of example only with reference to the accompanying drawings in which:

FIG. 1 depicts a hydraulic circuit for the purposes of illustrating embodiment of the method and system for operating an emergency brake in accordance with the present invention;

FIG. 2a depicts a pressure curve for a brake operated in accordance with an embodiment of the present method and system;

FIG. 2b depicts a brake torque curve for a brake operated in accordance with an embodiment of the present method and system; and,

FIG. 3 is a flow chart depicting one of a variety of different methods of applying the brake in accordance with the present invention.

### BRIEF DESCRIPTION OF PREFERRED EMBODIMENT

It is common for various types of machines, in particular, vehicles, to be fitted with emergency brakes which can be activated in the event that a service brake fails to operate. Such emergency brakes may also operate automatically in the event of a failure in an electrical system of the vehicle. In the case of a vehicle, the emergency brake may act either directly on:
a brake drum or rotor of one or more wheels of the vehicle; or,
the drive line and specifically on a drive shaft which transfers torque from an engine to a differential.

Embodiments of the present invention may be applied in relation to wheel brakes or a drive line brake. When applied as a drive line brake, the brake system may comprise a braking surface such as a rotor or drum coupled with a drive line component such as a drive shaft and at least one friction pad that can be pressed against the braking surface.

While the exact nature of the emergency brake is not critical to the present invention one form of emergency brake to which embodiments of the present invention may be applied is a spring applied hydraulic release emergency brake of the type described in U.S. Pat. No. 6,412,612.

This type of emergency brake has a fully released state when an associated brake line pressure is at a maximum pressure Pₘₐₓ, corresponding to a minimum braking torque Tₘᵢₙ , and a fully applied state when the brake line pressure is Pₘᵢₙ corresponding to a maximum braking torque Tₘₐₓ. Mechanical springs are used to push a brake pad against a rotating or otherwise moving member such as a drum or rotor. The force of the springs is counteracted by hydraulic pressure. The hydraulic pressure acts against the bias of the springs in which event the emergency brake is in an unapplied or OFF state allowing continued rotational movement of the member. When the hydraulic pressure is released, the springs, no longer being acted upon by hydraulic pressure are able to push the brake pads against the moving member to cause a braking effect.

FIGS. 1-3 depict an embodiment of the method and system 10 for operating a spring applied hydraulic release brake 18. However embodiments of the invention can also be applied to a hydraulic applied brake. In both types of brake the effect is the same in terms of applying braking torque automatically at a rate dependant on sensed speed of a motor vehicle or other machine to which the brake is coupled. In the case of a spring applied hydraulic released brake associated brake line pressure is reduced from Pₘₐₓ to Pₘᵢₙ; whereas for the hydraulic applied brake, associated brake line pressure is increased form Pₘᵢₙ to Pₘₐₓ.

The method in broad terms comprises, at step 12 in FIG. 3, sensing the speed of the machine or component of the machine or component of the machine, and in the event that the emergency brake is activated as indicated at step 14, automatically applying braking torque at a rate dependent on the sensed speed Vₛₑₜ, as depicted in step 16.

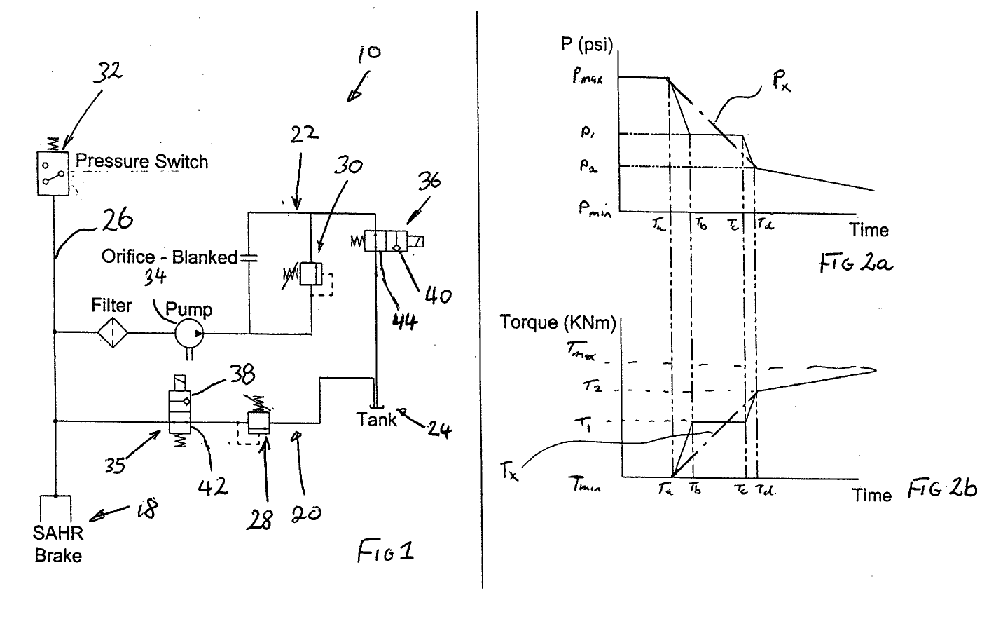

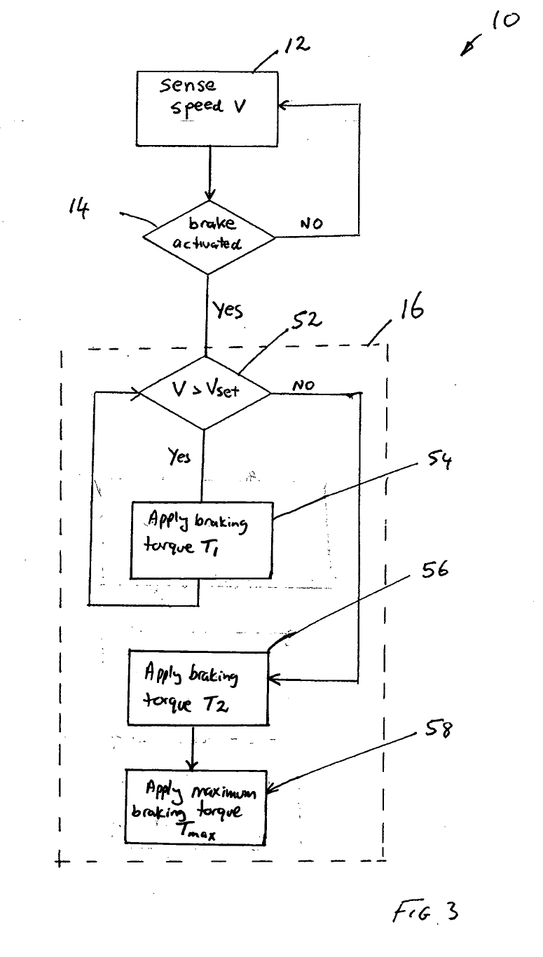

FIG. 1 depicts a hydraulic circuit for one embodiment of the system 10 for operating a spring applied hydraulic released brake 18. The system 10 comprises first and second fluid communication paths 20 and 22 respectively which provide fluid, and thus pressure communication between the brake 18 and a reservoir or a hydraulic fluid tank 24. The paths 20 and 22 are coupled in parallel between the tank 24 and a common brake line 26 of the brake 18. A first pressure relief valve 28 is provided in the first fluid communication path 20 for reducing brake line pressure, i.e. pressure in a brake line 26 to a pressure P₁ depicted in FIG. 2a.

Similarly, a second pressure relief valve 30 is provided in the second fluid communication path 22 to relieve brake line pressure to a pressure P₂ where Pₘₐₓ>P₁>P₂. When a machine to which the brake 18 and system 10 is fitted is in use, pressure in the brake line 26 is at a maximum pressure Pₘₐₓ and the fluid communication paths 20 and 22 are closed so that the pressure in the brake line acts against the bias of the springs and thus the brake 18 is in an unapplied or OFF state, and thus braking torque is at a minimum Tₘᵢₙ, which in practice will be, or close, to 0 Nm.

A pressure switch 32 is provided in the brake line 26 for operating a pump 34, to maintain pressure in the brake line 26 at Pₘₐₓ when the brake 18 is in an unapplied state.

In the event that the speed of the machine, for example, a vehicle is greater than a predetermined set speed Vₛₑₜ for example, 20 kilometres per hour, and the emergency brake is operated the system 10 initially opens the fluid communication path 20 causing a reduction in brake line pressure from Pₘₐₓ to P₁ and corresponding partial application of braking torque from Tₘᵢₙ to T₁. This is represented in FIGS. 2a and 2b. The partial application of the full braking torque reduces the load placed on the drive line. Sometime after the braking torque has increased to T₁ (i.e. brake line pressure has reduced to P₁), the second fluid communication path 22 is opened causing a reduction in brake line pressure from P₁ to P₂ and a corresponding increase in brake torque from T₁ to T₂. This commences at a time t_{d}, with the braking torque and brake line pressure reaching T₂ and P₂ at a time t_{d}.

Thereafter, the brake line pressure is allowed to bleed down to Pₘᵢₙ for example through a leakage path in one or both of the relief valves 28 and 30, providing a progressive increase in braking torque to the full braking torque Tₘₐₓ.

The time between opening of the first and second fluid communication paths 20 and 22, represented by the difference in time t_{b} and t_{d} can be determined using different criteria. One criteria may be related to speed the vehicle and another may be based on the effluxion of time independent of vehicle speed. For example, say the system 10 is applied to a vehicle where the speed Vₛₑₜ=20 k/h. If the vehicle is travelling at 50 km/hour and the emergency brake is activated, the fluid communication path 20 will initially open dropping the brake line pressure from Pₘₐₓ to P₁. The brake line pressure may then be held at P₁ or substantially at P₁ until the vehicle speed has been sensed as dropping below 20 kms per hour. At that time, time t_{c}, the second communication path 20 is opened allowing brake line pressure to drop from P₁ to P₂.

Alternate, if desired a simple counter may be applied or used in the system 10 to open the fluid communication path 22 either a preset time after opening of the fluid communication path 20, or alternately a preset time after the braking torque has reached T₁, corresponding to brake line pressure dropping to the pressure P₁.

In yet a further variation, a combination of vehicle speed and time delays may be incorporated to control the sequential opening of the paths 20 and 22. For example, in the above scenario if the vehicle speed is sensed as dropping to less than 20 km/h, the timer may operate to open the second path 22 say half a second after braking torque has reached T₁.

Respective two position solenoid operated check valves 35 and 36 are connected in series in the fluid communication paths 20 and 22. The valves 35 and 36 are configured so that when there respective solenoids are energised, their respective internal check valves 38 and 40 are connected into the fluid paths 20 and 22 which prevent a flow of fluid and communication of fluid pressure in the direction from the brake 18 to the tank 24. However, reverse fluid flow is possible through the respective check valves. This allows the pump 34 to operate to pressurise the brake line 26 to the pressure Pₘₐₓ as required by the pressure switch 32.

When the emergency brake is activated, power is cut off to the solenoid of the valve 35 causing the valve 34 to place its normally open port 42 in the path 20 allowing fluid communication between the brake line 26 and the tank 24 via the relief valve 28. The brake line pressure Pₘₐₓ is able to relieve or drop to the pressure P₁ through the valve 28. Similarly, when power to the solenoid of valve 36 is turned off, its normally open port 44 is connected into the path 20 allowing pressure in the brake line 26 to be relieved through the relief valve 30 to the pressure P₂.

The opening of the fluid communication paths 20 and 22 is also represented in FIG. 3 as the expansion of step 16 which comprises a number of sub steps.

The first of these is step 52 where a determination is made as to whether or not the sensed speed V>Vₛₑₜ. In the event that V is greater than Vₛₑₜ, then the method proceeds to step 54 where the braking torque applied is T₁. This corresponds to the brake line pressure being reduced to P₁ which is achieved by opening of the fluid communication path 20 (corresponding to de-energising the solenoid of valve 35). Thereafter, when speed V has dropped to or below Vₛₑₜ at step 56 the braking torque is increased to T₂ , by de-energising the solenoid of valve 36 thereby opening of the fluid communication path 22 and thus reducing brake line pressure is reduced to pressure P₂. Finally, the brake line pressure is allowed to bleed to Pₘᵢₙ (which typically is 0 psi) at step 58 representing maximum torque Tₘₐₓ applied by the brake. It may be the case that the maximum torque is not applied until after the vehicle has come to a complete stop.

In the event that step 52, it is determined that the speed of the vehicle V<Vₛₑₜ then the system may operate to increase braking torque from Tₘᵢₙ to T₂ by reducing brake line pressure from Pₘₐₓ to P₂. This is represented in FIGS. 2a and 2b by the lines Tₓ and Pₓ respectively. Thereafter, the braking torque progressive increases to Tₘₐₓ by virtue of the brake line pressure bleeding to Pₘᵢₙ.

The system and method 10 may further have provision for preventing the operation of a normal service brake when the emergency brake is activated. This may be achieved by way of a simple logic circuit which, upon detection of activation of the emergency brake (eg by detecting de-energising of the solenoids for valves 35 or 36) disables operation of the service brake.

Activation of the emergency brake may be via a switch in a cabin of a vehicle to which the system 10 is installed. The system 10 may also be configured to automatically operate to apply the emergency brake when an interlock is triggered. Examples of such an interlock include for example when the driver's and for a passenger's door is open or the driver's or indeed any passenger's seat belt is not engaged. The system 10 may comprise appropriate sensors to enable such operation or be coupled with or spliced into existing vehicle sensors for detecting such events.

Now that an embodiment of the present invention has been described in detail it would be apparent to those skilled in the relevant arts that numerous modifications and variations may be made without departing from the basic inventive concepts. For example, the system 10 described and illustrated has two fluid communication paths 20 and 22. However, more communication paths may be provided in parallel each providing automatic application of braking torque from Tₘᵢₙ to Tₘₐₓ via any number of graduated steps. In such an embodiment each of the paths may be opened either on the basis of different detected speeds of the machine or component thereof, or on the basis of the effluxion time independent of speed, or a combination thereof in the same manner as described hereinabove. For example there may be n paths for allowing brake line pressure to progressive bleed to pressures Pₘₐₓ>P₁>P₂ . . . Pₙ>Pₘᵢₙ, for the spring applied hydraulic released brake 18 (or to progressively increase from pressure Pₘᵢₙ to Pₙ< . . . P₂<P₁<Pₘₐₓ for a hydraulic applied brake) where n is an integer >2. In this embodiment the trigger speed for opening a particular path is Vₙ, ie V₁>V₂ . . . Vₙ. The path enabling braking torque to increase to torque T₁ corresponding with pressure relief to pressure P₁ is opened when sensed speed Vᵢ₋₁>V>V₁. In an example the trigger speeds may be V₁=110 kM/h, V₂=80 km/h, V₃=40 km/h and V₄=20 km/h. If sensed speed V=70 km/h then the appropriate fluid paths are opened to enable pressure relief from Pₘₐₓ to P₃, and braking torque to increase from Tₘᵢₙ to T₃. Thereafter the paths enabling pressure relief to pressures P₄ and Pₘᵢₙ are opened to allow progressive pressure reduction to Pₘᵢₙ and thus maximum braking torque.

The embodiment of the system 10 is shown in relation to a spring applied hydraulic released brake 18. However an embodiment of the system can be readily applied to a hydraulic applied brake by replacing the brake 18 with the tank 24, and fitting a brake to hydraulic circuit at the location occupied by the tank in FIG. 1 and changing the valves 35 and 36 to normally closed check valves. Thus maximum brake line pressure is available in the line 26, but this pressure can not be communicated to the brake when the paths 20 and 22 are closed. When the emergency brake is activated one or both of the paths 20, 22 is opened allowing the brake line pressure to communicated to the brake to effect braking.

All such modifications and variations together with others that would be obvious to a person of ordinary skill in the art are deemed to be within the scope of the present invention, the nature of which is to be determined from the above description and the appended claims.

1. A method of operating an emergency brake for arresting the motion of a motor vehicle, the method comprising:
sensing the speed V of the motor vehicle; and,
upon activating the emergency brake, automatically applying braking torque to a rotating component of the motor vehicle at a rate dependent on the sensed speed V.

2. The method according to claim 1 wherein automatically applying braking torque comprises when V>Vₛₑₜ increasing braking torque from Tₘᵢₙ to T₁; and subsequently increasing braking torque from T₁ to Tₘₐₓ; and,
when V<Vₛₑₜ increasing braking torque from Tₘᵢₙ to T₂, where Tₘₐₓ>T₂>T₁>Tₘᵢₙ.

3. The method according to claim 2 wherein when V>Vₛₑₜ, the step of subsequently increasing braking torque from T, to Tₘₐₓ comprises increasing braking torque from T₁ to T₂ where T₂>T₁>Tₘᵢₙ and subsequently increasing braking torque from T₂ to Tₘₐₓ.

4. The method according to claim 3 comprising when V>Vₛₑₜ, and the emergency brake is activated: providing a delay in increasing braking torque from T₁ to T₂.

5. A method of operating an emergency brake for arresting the motion of a motor vehicle where the emergency brake has a fully released state when an associated brake line pressure is at Pₘₐₓ and a fully applied state when brake line pressure is at Pₘᵢₙ where Pₘₐₓ>Pₘᵢₙ the method comprising:
sensing the speed V of the motor vehicle;
upon activating the emergency brake, automatically relieving brake line pressure at a rate dependent on the sensed speed V.

6. The method according to claim 5, wherein automatically relieving brake line pressure comprises relieving brake line pressure from Pₘₐₓ to P₁ when V>Vₛₑₜ where the Vₛₑₜ>0 and P₁>Pₘᵢₙ; and, subsequently relieving P₁ to Pₘᵢₙ; and,
relieving Pₘₐₓ to P₂ when V<Vₛₑₜ and subsequently relieving P₂ to Pₘᵢₙ, where P₁>P₂>Pₘᵢₙ.

7. The method according to claim 6, wherein when V>Vₛₑₜ the step of subsequently relieving P₁ to Pₘᵢₙ comprises relieving brake line pressure from P₁ to P₂ where P₁>P₂>Pₘᵢₙ and subsequently relieving brake line pressure from P₂ to Pₘᵢₙ.

8. The method according to claim 7, comprising when V>Vₛₑₜ, and the emergency brake is activated, delaying the relieving of the brake line pressure from P₁ to P₂.

9. The method according to claim 1 comprising automatically activating the emergency brake upon detection of an interlock event relating to operation of the vehicle.

10. The method according to claim 9 wherein detection of an interlock event comprises any one of (a) a driver's door of the vehicle being open; (b) any door of the vehicle being open; (c) a driver's seat belt being disengaged while a driver is on a driver's seat; (d) a passenger's seat being disengaged while a passenger is on a seat associated with the passenger's seat belt.

11. The method according to claim 1 comprising coupling the emergency brake with a drive line component of the motor vehicle wherein the emergency brake when activated applies braking torque to the drive line component.

12. A method of operating an emergency brake for arresting motion of a machine where the brake has a fully released state when an associated brake line pressure is at Pₘₐₓ and a fully applied state when brake line pressure is at Pₘₐₓ where Pₘₐₓ>Pₘᵢₙ, the method comprising:
providing n parallel fluid communication paths between the brake and a fluid tank where n is an integer >2, wherein said fluid communication paths are closed prior to activation of the emergency brake and each fluid communication path, when open, is configured to enable brake line pressure to be relieved to respective pressures P₁, P₂ . . . Pₙ where Pₘₐₓ>P₁>P₂> . . . >Pₙ>Pₘᵢₙ ;
sensing a speed V of the machine or a component thereof; and,
automatically opening one or more of the fluid communication paths upon activation of the emergency brake dependent on the sensed speed V.

13. The method according to claim 12 wherein the path enabling brake line pressure to be relieved to pressure Pᵢ is opened when Vᵢ₋₁>V>Vᵢ and the emergency brake is activated, where Vᵢ₋₁>Vᵢ.

14. The method according to claim 13 comprising, subsequent to the opening of the path to relieve brake line pressure to Pᵢ, sequentially opening each other path enabling progressive pressure relief to Pₘᵢₙ.

15-17. (canceled)

18. An emergency brake system having a brake with a fully released state where braking torque applied by the brake is at a minimum Tₘᵢₙ and an associated brake line pressure is at P_{A} and a fully applied state where braking torque applied by the brake is at a maximum Tₘₐₓ and brake line pressure is at P_{B} the emergency brake system comprising:
at least first and second fluid communication paths between the brake and a fluid tank, wherein each path is closed prior to activation of the emergency brake;
a first valve in the first fluid communication path configured to vary brake line pressure to P₁ to apply braking torque T₁;
a second valve in the second fluid communication path which is configured to vary brake line pressure to P₂ to apply a braking torque T₂ where Tₘₐₓ>T₂>T₁>T₁>Tₘᵢₙ;
a speed sensing device for sensing a speed V of a machine or a component thereof to which the emergency brake is coupled;
wherein one or both of the fluid communication paths is opened to automatically vary braking torque upon activation of the emergency brake dependent on the sensed speed V.

19. The emergency brake system according to claim 18 wherein:
when V>Vₛₑₜ and the emergency brake is activated, the first fluid communication path is opened to enable the brake to apply a braking torque of T₁; and subsequently apply braking torque Tₘₐₓ; and,
when V<Vₛₑₜ and the emergency brake is activated, the second fluid communication path is opened to enable the brake to apply braking torque of T₂ and subsequently apply braking torque of Tₘₐₓ.

20. The brake system according to claim 19 wherein when V>Vₛₑₜ, the second fluid communication path is opened after the braking torque has reached T₁ to subsequently enable the brake to apply braking torque T₂.

21. The brake system according to claim 20 wherein when V>Vₛₑₜ, and the emergency brake system is activated, there is a delay between the braking torque reaching T₁ brake line and subsequently opening the second fluid communication path.

22-23. (canceled)

24. The brake system according to claim 18 comprising, when the machine is a motor vehicle:a braking surface coupled with a drive line component of the motor vehicle and at least one friction pad wherein when the emergency brake is applied the at least one friction pad is pressed against the braking surface to apply braking torque to the drive line component.

25. The brake system according to claim 18 comprising a first normally open solenoid check valve in the first fluid communication path and a second normally open solenoid check valve in the second fluid communication paths wherein the first and second solenoid check valves are closed by supplying electrical power to the respective solenoid check valves.
